(19) United States
(12) Patent Application Publication
(10) Pub. No.: US 2007/0213963 A1
(43) Pub. Date: Sep. 13, 2007

(54) System And Method For Determining Flow Rates In A Well

(76) Inventors: Younes Jalali, Cambridge (GB); Ahmed M. Daoud, Cairo (EG)

Correspondence Address: SCHLUMBERGER TECHNOLOGY CORPORATION, 14910 AIRLINE ROAD, ROSHARON, TX, 77583, US

(21) Appl. No.: 10/575,030

(22) PCT Filed: Aug. 11, 2004
(86) PCT No.: PCT/IB04/02639

§ 371 Date: Dec. 19, 2006

Related U.S. Application Data
(60) Provisional application No. 60/510,595, filed on Oct. 10, 2003.

(51) Int. Cl. G06G 7/57

(52) U.S. Cl. 703/10

(57) ABSTRACT

A system and method is provided for determining flow rates of fluid in a well. The system and method utilize temperature measurements and a modeling technique that enable the determination of flow rates from one or more well zones via the temperature data.

### CROSS-REFERENCE TO RELATED APPLICATIONS

This application claims priority from Provisional Application 60/510,595, filed Oct. 10, 2003, which is incorporated herein by reference.

### BACKGROUND OF THE INVENTION

1. Field of the Invention

The present invention relates to a system and method for determining flow rates in a well, and particularly to determining flow rates from a sensed well parameter, such as temperature.

2. Description of Related Art

In a variety of wells, various parameters are measured to determine specific well characteristics. Typically, however, a logging string is lowered into a well to measure desired parameters at various points along a wellbore. The logging string is lowered into the wellbore separately from an actual production completion.

Thus, diagnosis of the well involves a separate, physical intervention into the well which increases cost and consumes time. In many applications, the logging string is used to measure a variety of parameters in an attempt to accurately determine the desired well characteristic or characteristics.

### BRIEF SUMMARY OF THE INVENTION

In general, the present invention provides a method and system for using a well model in utilizing well parameters sensed while an actual operational completion is deployed in a wellbore. For example, a model of temperature as a function of zonal rates can be utilized. Temperature measurements are taken along the wellbore, and the model is used as a tool in inverting the measured temperatures to allocate flow rates from one or more well zones.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of a completion and sensing system deployed in a wellbore, according to an embodiment of the present invention;

FIG. 2 is an elevation view of an embodiment of the system illustrated in FIG. 1 for determining flow rates from multiple formation layers with multiple phase liquids;

FIG. 3 is a flowchart generally representing an embodiment of the methodology used in determining flow rates in a well, according to an embodiment of the present invention;

FIG. 4 is a diagrammatic representation of a processor-based control system that can be used to carry out all or part of the methodology for determining flow rates in a given well, according to an embodiment of the present invention;

FIG. 5 is a flowchart generally representing use of a well model in combination with measured parameters, according to an embodiment of the present invention;

FIG. 6 is a diagrammatic chart generally representing error sources that may be determined and/or compensated for according to an embodiment of the present invention;

FIG. 7 is a diagrammatic representation of the system illustrated in FIG. 1 in which flow rates are determined in a single layer, single phase well;

FIG. 8 is a diagrammatic representation of the system illustrated in FIG. 1 in which flow rates are determined in a multi-layer, single-phase well; and

FIG. 9 is a diagrammatic representation of the system illustrated in FIG. 1 in which flow rates are determined in a multi-layer, multi-phase liquid well.

### DETAILED DESCRIPTION OF THE INVENTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a system and method for determining flow rates in a well. Temperature measurements are taken along a wellbore, and those measurements are used to determine fluid flow rates at distinct zones within the well. In some applications, the total flow at the wellhead is measured and this total flow is allocated among separate zones based on temperature measurements taken along the well. Additionally, the physical property contrasts between differing fluids, such as oil and water, can be used to allocate flow rates in multi-phase liquid wells. Accordingly, the present system and method enables the allocation of flow rates in multi-phase liquid, multi-layer wells.

Furthermore, the temperature sensing system is deployed with an operational completion and enables temperature measurements to be taken during operation of the well. Thus, the operation of the well deep downhole can be diagnosed without separate physical intervention into the well. An operator can continually diagnose zonal flow rates during operation of the well. Depending on the specific application, operation of the well may comprise production of fluids or injection of fluids into the surrounding formation.

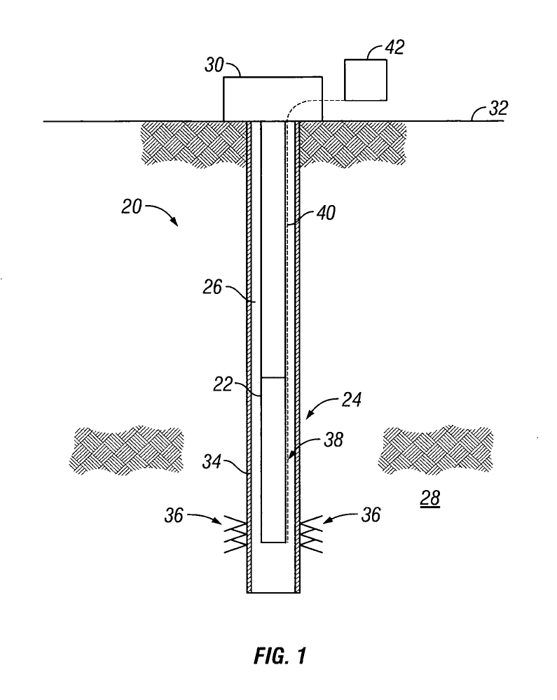

Referring generally to FIG. 1, a system 20 is illustrated in accordance with an embodiment of the present invention. System 20 comprises a completion 22 deployed in a well 24. Well 24 is defined by a wellbore 26 drilled in a formation 28 having, for example, one or more fluids, such as oil and water. Completion 22 extends downwardly into wellbore 26 from a wellhead 30 disposed, for example, along a seabed floor or a surface of the earth 32. In many applications, wellbore 26 is lined with a casing 34 having sets of perforations 36 through which fluid flows between formation 28 and wellbore 26. In the embodiment illustrated, wellbore 26 is generally vertical. However, the wellbore also may be a deviated wellbore.

As further illustrated, system 20 comprises a temperature sensing system 38. For example, temperature sensing system 38 may comprise a distributed temperature sensor (DTS) 40 that is capable sensing temperature continuously along wellbore 26. Distributed temperature sensor 40 may be coupled to a control 42 able to receive and process the temperature data obtained from multiple locations along wellbore 26. As discussed further below, control 42 also may enable using the temperature data in conjunction with a model of the well to derive flow rates from one or more wellbore zones.

By way of further explanation, completion 22 is representative of a variety of completions. Depending on the application, one or more production related completions may be utilized within wellbore 26. For example, valves, electric submersible pumping systems, and/or gas lift systems can be utilized in producing one or more fluid phases from one or more well layers, i.e. well zones. Other examples of completions include well treatment completions, such as injection systems for injecting fluids into formation 28 at one or more well zones.

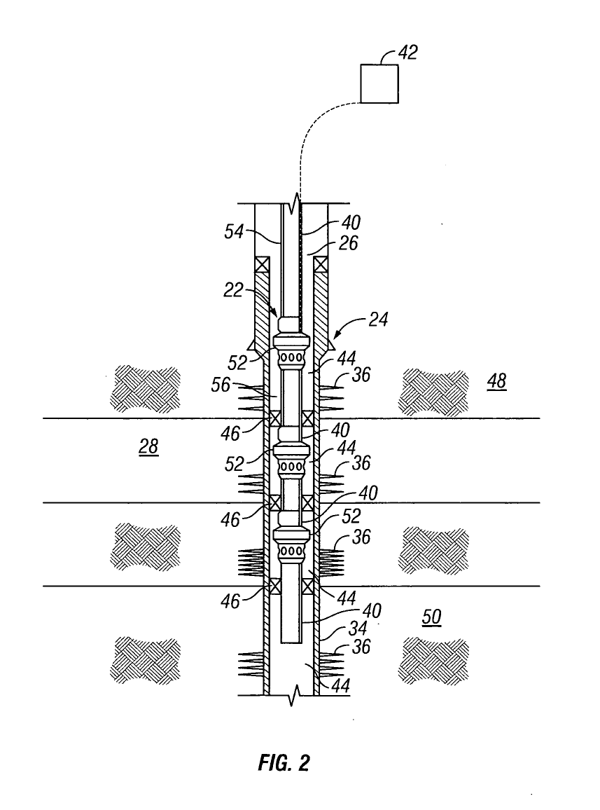

An example of a multizone production system is illustrated in FIG. 2. In this embodiment, several sets of perforations 36 are disposed along casing 34 to enable the inflow of fluid from formation 28 into wellbore 26. Specifically, the perforations 36 are located to enable the flow of fluid from a plurality of layers or zones 44 that form well 24. The multiple layers or zones 44 may comprise, for example, an upper producing zone 48 and a lower producing zone 50. Wellbore 26 also is divided into corresponding zones 44 via a plurality of packers 46. Fluid, such as oil or a combination of oil and water, flows from upper producing zone 48 and lower producing zone 50 into wellbore 26 so that it may be produced upwardly to an appropriate collection location, such as the surface of the earth. In this embodiment, completion 22 comprises a plurality of completion devices 52 that produce the fluid from the two or more zones. As discussed above, the completion devices 52 may comprise a variety of components, including electric submersible pumping systems, valves, gas lift systems, or other appropriate devices. Depending on the specific application, the produced fluids may be commingled or produced separately through one or more production tubings 54 or through an annulus 56 surrounding the one or more tubings. Also, the produced fluids may comprise multiphase liquids, such as mixtures of oil and water.

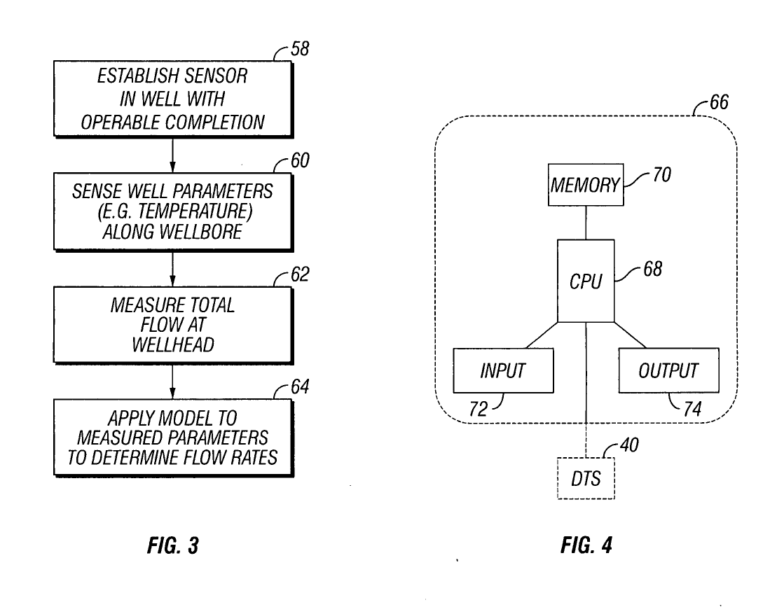

Referring generally to FIG. 3, an example of the methodology associated with the present invention is illustrated in flow chart form. Determining flow rates within a given well comprises establishing a sensor system in a well with an operable completion, as illustrated by block 58. The sensor system may comprise a distributed temperature sensor designed to sense well parameters, e.g. temperature, along wellbore 26, as illustrated by block 60. In many applications, a total flow is measured at an easily accessible location, such as at the wellhead 30, as illustrated by block 62. For example, a surface multiphase flow meter can be used to measure total flow at the wellhead. A well model may then be applied to determine flow rates from distinct well zones 44 based on the multiple temperature measurements, as illustrated by block 64.

Some or all of the methodology outlined with reference to FIGS. 1-3 may be carried out by controller 42 which comprises an automated system 66, such as the processing system diagrammatically illustrated in FIG. 4. Automated system 66 may be a computer-based system having a central processing unit (CPU) 68. CPU 68 may be operatively coupled to a distributed temperature sensor system 40, a memory 70, an input device 72, and an output device 74. Input device 72 may comprise a variety of devices, such as a keyboard, mouse, voice-recognition unit, touchscreen, other input devices, or combinations of such devices. Output device 74 may comprise a visual and/or audio output device, such as a monitor having a graphical user interface. Additionally, the processing may be done on a single device or multiple devices at the well location, remote from the well location, or with some devices located at the well and other devices located remotely.

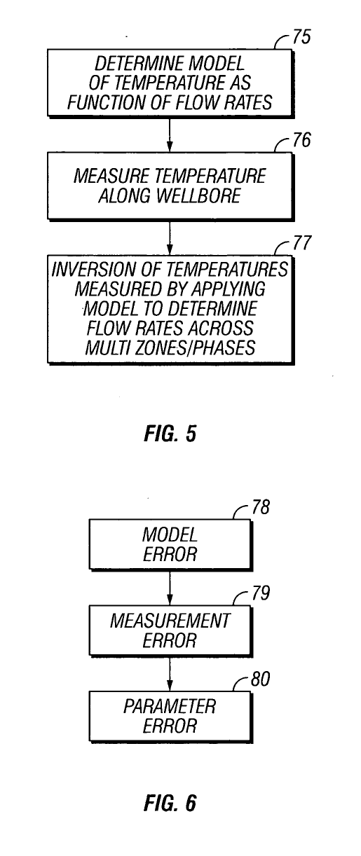

In automatically determining flow rates from well zones 44, a model of temperature as a function of zonal rates for a specific well may be stored by automated system 66 in, for example, memory 70. The forward model is used as a tool to invert the measured temperatures along wellbore 26 and allocate the flow rates from the different producing zones. As illustrated best in FIG. 5, the general approach involves determining a model of temperature as a function of flow rates, as illustrated by block 75. The temperatures at various locations along wellbore 26 are measured, as illustrated by block 76, and the data may be stored by automated system 66. Subsequently, an inversion of the measured temperatures is performed by applying the model to determine flow rates, as illustrated by block 77. Appropriate models enable the allocation of flow rates across multiple zones flowing multiple liquid phases. It should also be noted that in at least some applications gas holdup increases toward the surface in a production string. However, the theoretical basis of the modeling discussed herein is not violated in such wells when temperatures are measured in the region of the producing interval(s).

In general, the inversion process begins with a model incorporating the physics of the well to the extent possible. Flow rates from the different layers or zones of the well are then applied to the model which provides temperatures. The calculated temperatures are compared to measured temperatures, and the model is adjusted (e.g. by adjusting the estimate of oil and water coming from each zone) so the calculated temperatures match the measured temperatures. Also, the total flow rate at the surface can be used as a control for the sum of the allocated flow rates.

The process may also involve the evaluation of and/or compensation for potential errors in the model and the inversion process. Potential sources of error are set forth in the chart of FIG. 6. The overall methodology can be used to determine under what conditions flow rates may be allocated with a desired degree of certainty or confidence. This is accomplished for a given well by estimating error in zonal rates due to, for example, model error (see block 78 of FIG. 6), measurement error (block 79), and parameter error (block 80). The methodology of determining and compensating for errors may be incorporated into the inversion process illustratively set forth by block 77 of the flow chart illustrated in FIG. 5.

Referring again to FIG. 6, the model error is a byproduct of the model being an approximate representation of the key physical processes taking place in the wellbore, such as Joule-Thomson cooling at the sandface. The determination and/or compensation for such error can improve the usefulness of the model. The desire to determine and compensate for measurement error, on the other hand, results from potential limitations and/or characteristics of the sensor system, e.g. the distributed temperature sensor. For example, finite resolution of the sensor or sensor system can introduce a degree of error. Furthermore, determining and compensating for parameter error may be desirable due to, for example, an imprecise knowledge of well parameters, such as relevant rock and fluid properties, e.g. thermal properties of the formation. The model and inversion process is able to determine and compensate for such errors in many applications, as discussed below.

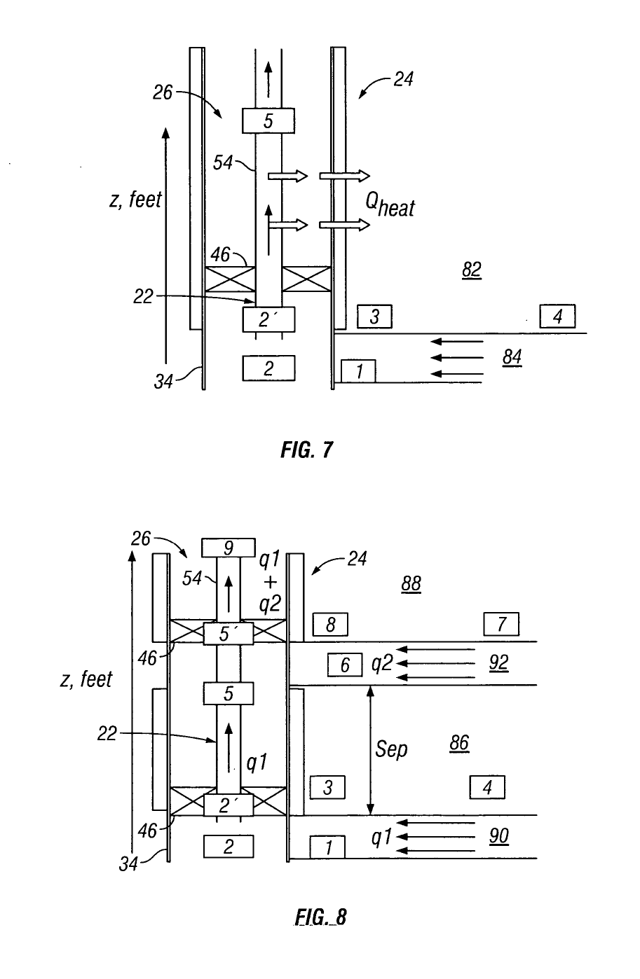

In the following discussion, a detailed description is provided for a methodology of temperature forward modeling of specific well examples. In the first example, the well 24 is a single layer production well having a nonproducing zone 82 and a producing zone 84, as illustrated in FIG. 7. The completion 22 extends downwardly into wellbore 26 through a single packer 46. The schematic representation illustrates a thermal nodal analysis used to develop a mathematical temperature model by determining the temperature at each of a plurality of nodes, labeled 1, 2, 2′, 3, 4, and 5, using mass, momentum, and energy balance equations.

In this example, the temperature nomenclature at each node is as follows:
node 1—bottom hole formation temperature calculated from the earth geothermal gradient, T_{eibh};
node 2—bottom hole flowing fluid temperature, T_{fbh1};
node 2′—flowing fluid temperature at the top of the producing zone, T_{fbh2};
node 3—formation temperature at the well/earth interface in the nonproducing zone;
node 4—formation temperature calculated from the earth geothermal gradient in the nonproducing zone, Tₑᵢ; and
node 5—flowing temperature, T_{f}, at any depth z from the producing zone.

Furthermore, to facilitate an understanding of the mathematical basis for the model, brief explanations of symbols used in the subsequent description of the model are as follows:

Û—Specific internal energy, BTU/lbm;

Ĥ—Specific enthalpy, BTU/lbm;

\hat{V}—Specific volume, ft³/lbm;

α—Thermal diffusivity of earth, ft²/hr;

μ—Viscosity, cp;

φ—Constant for friction factor given by Eq. 1.36;

θ—Angle of inclination of the well with horizontal, degrees;

ρ—Density, lbm/ft³;

μ₁—Viscosity of the fluid flowing from the lower zone, cp;

ρ₁—Density of the fluid produced from lower producing zone, lbm/ft³;

μ₂—Viscosity of the fluid flowing from the upper zone, cp;

φ_{D}—Dimensionless number, given by Eq. 1.41;

ρₑ—Earth density, lbm/ft³;

γ_{g}—Gas specific gravity (air=1);

μ_{JT}—Joule-Thomson coefficient, F/psi;

ρₒ—Oil density, lbm/ft³;

γₒ—Oil specific gravity;

μₒ₁—Viscosity of oil produced from the lower producing zone, cp;

μₒ₂—Viscosity of oil produced from the upper producing zone, cp;

ρ_{w}—Water density, lbm/ft³;

γ_{w}—Water specific gravity;

μ_{w1}—Viscosity of water produced from the lower producing zone, cp;

μ_{w2}—Viscosity of water produced from the upper producing zone, cp;

A_{D}—Dimensionless number given by Eq. 1.40;

B—Formation volume factor, bbl/stb;

Cₑ—Specific heat of earth, BTU/lbm-F;

Cₚ—Specific heat of liquid, BTU/lbm-F;

Cₚ₍ᵢ₎—Specific heat of liquid inside the producing zone, BTU/lbm-F;

Cₚ₁—Specific heat of liquid produced from the lower zone, BTU/lbm-F;

Cₚ₂—Specific heat of liquid produced from the upper zone, BTU/lbm-F;

C_{p5′}—Specific heat of liquid at node 5′, BTU/lbm-F;

C_{pM}—Specific heat of liquid after the mixing, BTU/lbm-F;

Cₚₒ—Specific heat of oil, BTU/lbm-F;

C_{pw}—Specific heat of water, BTU/lbm-F;

f—Friction factor;

g—Acceleration of gravity, 32.2 ft/sec²;

g_{c}—Conversion factor, 32.2 ft-lbm/sec²-lbf;

GLR—Gas liquid ratio, scf/stb;

G_{T}—Geothermal gradient, F/foot;

h—Formation thickness, feet;

i—Index for number of temperature measurements in the producing zones;

I₀—Modified Bessel function I of order 0;

I₁—Modified Bessel function I of order 1;

J—Conversion factor, 778 ft-lbf/BTU;

K—Permeability, md;

K.E.—Kinetic Energy;

K₀—Modified Bessel function K of order 0;

K₁—Modified Bessel function K of order 1;

Kₐₙ—Thermal conductivity of material in annulus, BTU/D-ft-F;

K_{anw}—Thermal conductivity of water in annulus, BTU/D-ft-F;

K_{cem}—Thermal conductivity of cement, BTU/D-ft-F;

Kₑ—Thermal conductivity of earth, BTU/D-ft-F;

L—Total length of the well, feet;

m—Vector for input parameters for the forward model;

n—Total number of temperature measurements in the producing zone;

O—Objective function;

P—Pressure, psi;

P.E.—Potential Energy;

Pₑ—Reservoir pressure, psi;

P_{wf}—Flowing well pressure, psi;

q—Flow rate;

Q—Heat transfer between fluid and surrounding area, BTU/lbm;

q₁—Flow rate from the lower producing zone;

q₂—Flow rate from the upper producing zone;

qₒ—Oil flow rate, STB/D;

qₒ₁—Oil flow rate from the lower zone, STB/D;

qₒ₂—Oil flow rate from the upper zone, STB/D;

q_{oT}—Total oil flow rate from the two zones, STB/D;

q_{w}—Water flow rate, STB/D;

q_{w1}—Water flow rate from the lower zone, STB/D;

q_{w2}—Water flow rate from the upper zone, STB/D;

q_{wT}—Total water flow rate from the two zones, STB/D;

r—Radius, inches;

r_{ci}—Inside casing radius, inches;

r_{co}—Outside casing radius, inches;

r_{D}—Dimensionless radius;

Rₑ—Reynolds number, dimensionless;

rₑ—Drainage radius, feet;

r_{eD}—Dimensionless drainage radius;

rₜᵢ—Inside tubing radius, inches;

rₜₒ—Outside tubing radius, inches;

r_{wb}—Wellbore radius, inches;

s—Dummy variable in the Laplace domain;

t—Time, hours;

T—Temperature, F;

T₅—Temperature at node 5, F;

T_{5′}—Temperature at node 5′, F;

T₆—Temperature at node 6, F;

t_{D}—Dimensionless time;

Tₑ—Earth temperature, F;

T_{eD}—Earth dimensionless temperature;

Tₑᵢ—Earth temperature at any depth and far away from the well, F;

T_{eibh}—Earth temperature at the bottom hole of the well, F;

T_{f}—Fluid temperature at any depth, F;

T_{f(i)}—Flowing temperature in the well in front of the upper producing zone, F;

T_{fbh}—Fluid temperature at the bottom hole of the well, F;

T_{fbh(i)}—Flowing temperature in the well in front of the lower producing zone, F;

T_{fbh1}—Temperature in the wellbore at the bottom of the lower producing zone, F;

T_{fbh2}—Temperature in the wellbore at the top of the lower producing zone, F;

T_{fD}—Dimensionless fluid temperature;

T_{fdbh}—Dimensionless temperature in the wellbore at the fluid entry for each well section, F;

Tₕ—Temperature at the cement/earth interface, F;

Tᵢ^{cal}—Calculated temperature, F;

Tᵢ^{obs}—Observed or measured temperature, F;

U—Overall heat transfer coefficient, BTU/D-ft²-F;

v—Local fluid velocity, feet/sec;

wₜ—Total mass flow rate, lbm/sec;

z—Height from the bottom of the hole, feet;

z_{D}—Dimensionless height;

z_{dbh}—Dimensionless depth at the fluid entry for each well section.

The material balance equations are written in general form as follows:

Mass Balance Equation:
Rate of increase of mass=rate of mass in−rate of mass out (1.0)
Momentum Balance Equation:
Rate of increase of momentum=rate of momentum in−rate of momentum out+external force on the fluid (1.00)
Energy Balance Equation:
Rate of change of (internal energy+K.E.+P.E. due to convection)+(net rate of heat addition by conduction)−(net rate of work done by the system on the surrounding)=(Rate of accumulation of internal energy+K.E+P.E) (1.000)

Producing zone (node 1 and 2):

The general energy balance equation is written in terms of enthalpy as follows:
Rate of change of (enthalpy+K.E.+P.E. due to convection)+(net rate of heat addition by conduction)−(net rate of work done by the system on the surrounding)=(Rate of accumulation of enthalpy+K.E+P.E) (1.1)
The general energy balance equation (Eq. 1.1) is:
dĤ=0.0 (1.2)
From the basic thermodynamic principles, dĤ can be obtained from the following equation:
dĤ=CₚdT−μ_{JT}CₚdP (1.3)
Where, μ_{JT} is the Joule-Thomson coefficient and can be obtained from the following equation:

$${μ}_{JT} = {[ \frac{\partial T}{\partial p} ]}_{\hat{H}} = \frac{1}{{C}_{p}} [ {T ( \frac{\partial \hat{V}}{\partial T} )}_{p} - \hat{V} ] \qquad ( 1.4 )$$

For incompressible or slightly compressible fluid, ρ=constant, \hat{V}=constant,

$$∴ {[ \frac{\partial \hat{V}}{\partial T} ]}_{P} = 0.0 \qquad ( 1.5 )$$

From Eqs. 1.5, 1.4, and 1.2, Eq. 1.3 will be:

$$\begin{matrix}d \hat{H} = {C}_{p} dT + \hat{V} dP = 0.0 & ( 1.6 ) \\ ∴ {C}_{p} dT = - \frac{dP}{ρ} & ( 1.7 )\end{matrix}$$

Solving Eq. 1.7 leads to Eq 1.8, which is written in the field unit as follows:

$${T}_{fbh 1} = {T}_{eibh} + \frac{144 \cdot ( {P}_{e} - {P}_{wf} )}{{ρ}_{f} \cdot {C}_{p} \cdot J} \qquad ( 1.8 )$$

Eq. 1.8 indicates that only the effect of Joule-Thomson coefficient is dominant in calculating the temperature at node 2 by knowing the temperature at node 1 due to the flow through the perforations. The pressure drop can be calculated using the following equation by knowing reservoir rock and fluid properties and assuming a steady state flow:

$$( {P}_{e} - {P}_{wf} ) = \frac{141.2 q μ B}{K h} ln ( \frac{{r}_{e}}{{r}_{wb}} ) \qquad ( 1.9 )$$

In front of the Producing zone (node 2-2′)

To obtain an expression for the temperature, the producing zone is divided into equal intervals, each interval producing equal rate. The number of divisions depends upon the number of temperature measurements in the producing zone. By applying a macroscopic mass and energy balance due to the mixing of two streams, the temperature is obtained at any interval inside the producing zone using the following derived equation:

$${T}_{fbh ( i )} = \frac{( i - 1 ) {T}_{fbh ( i - 1 )} + {T}_{ei}}{i} \qquad ( 1.10 )$$

Where, i=2, 3, . . . , n (n is the number of temperature measurements inside the producing zone), taking into consideration that T_{fbh1} is calculated from Eq. 1.8 and 1.9 before. Also, Tₑᵢ should be corrected due to the pressure drop across the perforation using the same Eqs. 1.8 and 1.9 but using Tₑᵢ instead of T_{eibh}
As the fluids produced from each interval inside the producing zone have equal rate and equal specific heat capacity, Cₚ, so Eq. 1.10 can be written in the following form:

$${T}_{fbh ( i )} = \frac{( i - 1 ) {T}_{fbh ( i - 1 )} + {T}_{ei}}{i} \qquad ( 1.11 )$$

Accordingly, temperature at node 2′ will be:
T_{fbh2}=T_{fbh(n)} (1.12)
It should be noted that Eq. 1.11 is rate independent as it depends upon assuming that at each interval inside the producing zone, the producing rates are equal and the sum of those individual rates is the total producing rate from this producing zone, accordingly a condition is imposed such that at no production or physically at neglected production, Eqs. 1.10 and 1.11 do not hold and in this case the temperatures inside the producing zone should be equal to the geothermal temperature.

Non Producing zone (node 4-3)

As fluid is produced, heat is transferred by convection inside the wellbore and some of this heat is lost by conduction to the non-producing formation. Thus, inside the non-producing zone, the transport phenomenon is only the heat energy due to heat loss from the wellbore to the non-producing zone. So the only balance equation required is the energy balance equation. By applying the general energy balance equation given in Eq. 1.1 between node 3 and 4, the equation becomes:

$$\frac{{\partial }^{2} T}{\partial {r}^{2}} + \frac{1}{r} \frac{\partial {T}_{e}}{\partial r} = \frac{{c}_{e} {ρ}_{e}}{{K}_{e}} \frac{\partial {T}_{e}}{\partial t} \qquad ( 1.13 )$$

It should be mentioned that Eq. 1.13 is in 1D radial with the most common assumption that the earth density is unvaried with space and also with constant earth thermal conductivity.
Eq. 1.13 can be converted to the dimensionless form by using the following dimensionless variables:

$${T}_{eD} = - \frac{2 π {K}_{e}}{{w}_{t} ( \frac{ⅆ Q}{ⅆ z} )} ( {T}_{h} - {T}_{ei} ) \qquad ( 1.14 )$$

Where Tₕ is the temperature at node 3

$$\begin{matrix}{r}_{D} = \frac{r}{{r}_{wb}} & ( 1.15 ) \\ {t}_{D} = \frac{{K}_{e}}{{ρ}_{e} {c}_{e} {r}_{wb}^{2}} t = \frac{α}{{r}_{wb}^{2}} t & ( 1.16 )\end{matrix}$$

The radial partial differential equation of temperature distribution in earth in dimensionless form will be:

$$\frac{{\partial }^{2} {T}_{eD}}{\partial {r}_{D}^{2}} + \frac{1}{{r}_{D}} \frac{\partial {T}_{eD}}{\partial {r}_{D}} = \frac{\partial {T}_{eD}}{\partial {t}_{D}} \qquad ( 1.17 )$$

Eq. 1.17 can be solved using the following initial and boundary conditions:
Initial Condition:

$${lim}_{{t}_{D} \to 0} {T}_{eD} = 0 ,$$

Temperature is constant (equal Tₑᵢ, which is the earth temperature at any given depth and at infinite distance away from the well, temperature at node 4).
Boundary Conditions:
Outer Boundary Condition:

$${lim}_{{r}_{D} \to {r}_{eD}} \frac{\partial {T}_{eD}}{\partial {r}_{D}} = 0$$

(No change in temperature at infinite r_{D})
Inner Boundary Condition:

$$\frac{\partial {T}_{eD}}{\partial {r}_{D}} {\vert}_{{r}_{D = 1}} = - 1$$

(rate of flow of heat from the wellbore to the surrounding earth across an element dz is constant).
Eq. 1.17 is converted to the Laplace domain and may be solved using known Mathematica® software. The solution of T_{eD} in the Laplace domain (T_{eD}(S)) is in the following form:

$$\frac{\begin{matrix}{I}_{1} ( \sqrt{s} {r}_{eD} ) \cdot {K}_{0} ( \sqrt{s} \cdot {r}_{D} ) + \\ {I}_{0} ( \sqrt{s} \cdot {r}_{D} ) \cdot {K}_{1} ( \sqrt{s} \cdot {r}_{eD} )\end{matrix}}{{s}^{3 / 2} [ \begin{matrix}{I}_{1} ( \sqrt{s} \cdot {r}_{eD} ) \cdot {K}_{1} ( \sqrt{s} ) - \\ {I}_{1} ( \sqrt{s} ) \cdot {K}_{1} ( \sqrt{s} \cdot {r}_{eD} )\end{matrix} ]} \qquad ( 1.18 )$$

Where, s is a dummy variable for the Laplace domain, and I₀, I₁, K₀, K₁ are the modified Bessel functions. Eq. 1.18 is the cylindrical source solution of Eq. 1.17 which can be difficult to invert to the time domain analytically. Accordingly, the Gaver functional, Wynn-Rho algorithm, that is coded in Mathematica® software, may be used to get the inversion numerically by setting r_{eD} to a very high value (e.g. 1000) and r_{D} to 1 in obtaining the T_{eD} at the well/earth interface.
An approximation to the solution of Eq. 1.17 at the well/earth interface using the same initial and boundary condition has been accomplished by Hasan, A. R. and Kabir, C. S. as outlined in their paper entitled “Heat Transfer During Two-Phase Flow in Wellbores: Part I—Formation Temperature,” SPE 22866 presented at the 66^{th} Annual Technical Conference and Exhibition, Dallas, Tex., Oct. 6-9, 1991, in which the following equation was obtained:

$$\begin{matrix}{T}_{eD} {\vert}_{{r}_{D} = 1} = 1.1281 \sqrt{{t}_{D}} ⌊ 1 - 0.3 \sqrt{{t}_{D}} ⌋ if {t}_{D} \leq 1.5 & ( 1.19 ) \\ {T}_{eD} {\vert}_{{r}_{D} = 1} = [ 0.4063 + 0.5 ln ( {t}_{D} ) ] \cdot [ 1 + \frac{0.6}{{t}_{D}} ] if {t}_{D} > 1.5 & ( 1.20 )\end{matrix}$$

A comparison between the solution using the numerical Laplace inversion and that obtained from the Hasan and Kabir solution shows that most of the points range from 10⁻¹⁰ days to 10,000 days and lie on a 45° line so, for simplicity, Eqs. 1.19 and 1.20 may be used to get the temperature at node 3 by knowing the temperature at node 4 obtained from the geothermal gradient.

Well Path (node 2′-5)

As the fluid proceeds from node 2′ to 5, heat energy is transported by convection and also mass and momentum are transported due to the fluid flow. So, energy, mass, and momentum balance equations are applied between node 2′ and 5.
The general energy and mass balance equation is as follows:

$$\frac{ⅆ \hat{H}}{ⅆ z} = - \frac{\partial Q}{\partial z} - v \frac{\partial v}{\partial z} - g Sin θ \qquad ( 1.21 )$$

For radial heat transfer from the wellbore fluid to the well (cement)/earth interface,

$$\frac{ⅆ Q}{ⅆ z} = \frac{2 π {r}_{ti} U}{{w}_{t}} ( {T}_{f} - {T}_{h} ) \qquad ( 1.22 )$$

Where, Tₕ is the temperature at node 3 and wₜ is the total mass flow rate, which is calculated as follows:

$${w}_{t} = \frac{{q}_{g} {γ}_{g}}{1.1309 \times {10}^{6}} + \frac{{q}_{w} {γ}_{w} + {q}_{o} {γ}_{o}}{246.6} \qquad ( 1.22 a )$$

The radial heat transfer from the well (cement)/earth interface to the surrounding can be obtained from Eq. 1.14 which is the definition of the dimensionless earth temperature,

$$\frac{ⅆ Q}{ⅆ z} = \frac{2 π {K}_{e}}{{w}_{t} {T}_{eD}} ( {T}_{h} - {T}_{ei} ) \qquad ( 1.23 )$$

From Eq. 1.22 and 1.23,

$$\frac{ⅆ Q}{ⅆ z} = \frac{2 π}{{w}_{t}} [ \frac{{r}_{ti} {UK}_{e}}{{K}_{e} + {T}_{eD} {r}_{ti} U} ] ( {T}_{f} - {T}_{ei} ) \qquad ( 1.24 )$$

From the basic thermodynamic principles or from Eq. 1.3, the specific enthalpy can be taken from the following formula:

$$\frac{ⅆ \hat{H}}{ⅆ z} = - {μ}_{jT} {c}_{p} \frac{ⅆ p}{ⅆ z} + {c}_{p} \frac{ⅆ {T}_{f}}{ⅆ z} \qquad ( 1.25 )$$

By substituting Eq. 1.25 and Eq. 1.24 in Eq. 1.21, the final energy balance equation for the fluid in the producing well is:

$${c}_{p} \frac{ⅆ {T}_{f}}{ⅆ z} = - \frac{2 π}{{w}_{t}} [ \frac{{r}_{ti} {UK}_{e}}{{K}_{e} + {T}_{eD} {r}_{ti} U} ] ( {T}_{f} - {T}_{ei} ) - g Sin θ + {μ}_{JT} {C}_{p} \frac{ⅆ p}{ⅆ z} - v \frac{ⅆ v}{ⅆ z} \qquad ( 1.26 )$$

Where, U is the overall heat transfer coefficient and can be calculated from Eq. 1.27 under the following conditions:
a—Thermal resistance of pipe and steel are negligible compared to the thermal resistance of the fluid in the tubing/casing annulus,
b—Radiation and convection coefficients are negligible and can be ignored

$$U = {[ {r}_{ti} \frac{ln ( \frac{{r}_{ci}}{{r}_{to}} )}{{K}_{an}} + {r}_{ti} \frac{ln ( \frac{{r}_{wb}}{{r}_{co}} )}{{K}_{cem}} ]}^{- 1} \qquad ( 1.27 )$$

Eq. 1.26 is considered as a general equation for the temperature distribution inside the wellbore between node 2′ and 5 after combining both mass and energy balance equations. Eq. 1.26 can be applied for both single and multi-phase flow. By applying the momentum and mass balance equation, the term

$$( \frac{ⅆ p}{ⅆ z} )$$

can be obtained as follows:

$$\frac{ⅆ p}{ⅆ z} = - ρ v \frac{ⅆ v}{ⅆ z} - ρ g sin θ - \frac{ⅆ p}{ⅆ z} {\vert}_{friction} \qquad ( 1.28 )$$

Substituting Eq. 1.28 in Eq. 1.26,

$${c}_{p} \frac{ⅆ {T}_{f}}{ⅆ z} = - \frac{2 π}{{w}_{t}} [ \frac{{r}_{ti} {UK}_{e}}{{K}_{e} + {T}_{eD} {r}_{ti} U} ] ( {T}_{f} - {T}_{ei} ) - g Sin θ + {μ}_{JT} {C}_{p} ( - ρ v \frac{ⅆ v}{ⅆ z} - ρ g sin θ - \frac{ⅆ p}{ⅆ z} {\vert}_{friction} ) - v \frac{ⅆ v}{ⅆ z} \qquad ( 1.29 )$$

The analytical solution to Eq. 1.29 depends upon the Joule-Thomson coefficient, which may be obtained for different applications, such as a single phase liquid (oil or water production), two phase liquid (oil and water production), single-phase gas, and multi-phase (oil, water, and gas) as described below. In a single phase liquid example, consider black oil production below the bubble point pressure in which the distributed temperature sensor is analyzed very close to the producing intervals in which gas hold up is usually very small compared to that on the surface, so that the assumption of constant density and that the pressure is below the bubble point pressure is applicable at a very small interval close to the producing zone for a black oil production. From Eq. 1.4 for \hat{V}=constant, the Joule-Thomson coefficient becomes:

$${μ}_{JT} = \frac{- 1}{ρ {C}_{p}} \qquad ( 1.30 )$$

By substituting Eq. 1.30 into Eq. 1.29 and writing the equation in field units,

$$\frac{ⅆ {T}_{f}}{ⅆ z} = - \frac{2 π}{{w}_{t} {C}_{p}} [ \frac{{r}_{ti} {UK}_{e}}{{K}_{e} + {T}_{eD} \frac{{r}_{ti}}{12} U} ] \cdot [ \frac{1}{12 \times 86 \text{,} 400} ] ( {T}_{f} - {T}_{ei} ) + \frac{144}{J ρ {C}_{p}} \frac{ⅆ p}{ⅆ z} {\vert}_{friction} \qquad ( 1.31 )$$

The pressure loss due to friction can be obtained from the equations as follows:

$$\frac{ⅆ p}{ⅆ z} {\vert}_{friction} = \frac{2.956 \times {10}^{- 12} f ρ {q}^{2}}{{D}_{ti}^{5}} \qquad ( 1.32 )$$

Where the friction loss coefficient, f, can be obtained as follows:

$$If {R}_{e} \leq 2000 , \\ f = \frac{16}{{R}_{e}} , \\ if {R}_{e} > 2000 \frac{1}{\sqrt{f}} = - 3.6 log [ \frac{6.9}{{R}_{e}} + {( \frac{e}{3.7 {D}_{ti}} )}^{10 / 9} ] \qquad ( 1.33 )$$

Where Rₑ is the Reynolds number and can be obtained as follows:

$${R}_{e} = \frac{0.1231 ρ q}{{D}_{ti} μ} \qquad ( 1.34 )$$

By substituting Eqs. 1.32, 1.33, and 1.34 into Eq. 1.31, Eq. 1.31 becomes:

$$\begin{matrix}\frac{ⅆ {T}_{f}}{ⅆ z} = - \frac{2 π}{{w}_{t} {C}_{p}} [ \frac{{r}_{ti} {UK}_{e}}{{K}_{e} + {T}_{eD} \frac{{r}_{ti}}{12} U} ] \cdot [ \frac{1}{12 \times 86 \text{,} 400} ] ( {T}_{f} - {T}_{ei} ) + ϕ & ( 1.35 ) \\ Where , ϕ = \frac{144}{J} \cdot \frac{2.956 \times {10}^{- 12} f {q}^{2}}{{D}_{ti}^{5} {C}_{p}} & ( 1.36 )\end{matrix}$$

Tₑᵢ is calculated by knowing the earth temperature at the bottom hole (T_{eibh}), which is a fixed quantity, and the earth temperature gradient using the following equation:
Tₑᵢ=T_{eibh}−G_{T}z Sin θ (1.37)
Eq. 1.35 can be converted to a dimensionless form using the following dimensionless parameters:

$$\begin{matrix}{T}_{fD} = \frac{{T}_{f}}{{T}_{fbh}} & ( 1.38 ) \\ {z}_{D} = \frac{z}{L} & ( 1.39 ) \\ {A}_{D} = \frac{- 2 π L}{{w}_{t} {c}_{p}} [ \frac{{r}_{ti} {UK}_{e}}{{K}_{e} + {T}_{eD} \frac{{r}_{ti}}{12} U} ] \cdot [ \frac{1}{12 \times 86 \text{,} 400} ] & ( 1.40 ) \\ {ϕ}_{D} = \frac{ϕ L}{{T}_{fbh}} & ( 1.41 )\end{matrix}$$

By substituting Eq. 1.37 and the dimensionless forms, Eqs. 1.38 to 1.41, Eq. 1.35 becomes:

$$\frac{ⅆ {T}_{fD}}{ⅆ {z}_{D}} = {A}_{D} ( {T}_{fD} - \frac{{T}_{eibh}}{{T}_{fbh}} + \frac{{G}_{T} Sin θ {z}_{D} L}{{T}_{fbh}} ) + {ϕ}_{D} \qquad ( 1.42 )$$

The boundary condition used to solve the above ordinary differential equation is T_{jD}(z_{D}=0)=1 This means that the temperature at the bottom hole is equal to T_{fbh}. This boundary condition is suitable for dealing with a production from a single layer. Another boundary condition should be used if dealing with the solution of Eq. 1.42 in multi-layer producing wells, as will become apparent in the following description. It should be noted here that the origin of the z scale is at the bottom hole. The solution of Eq. 1.42 may be achieved using the Mathematica® software to obtain the profile of the dimensionless fluid temperature inside the well in front of the nonproducing zones as a function of the dimensionless depth and the solution is as follows:

$${T}_{fD} = \frac{\begin{matrix}- {G}_{T} Sin θ L - {A}_{D} {G}_{T} Sin θ {z}_{D} L + {A}_{D} {T}_{eibh} - {T}_{fbh} {ϕ}_{D} + \\ exp ( {A}_{D} {z}_{D} ) \cdot [ {G}_{T} Sin θ L + {A}_{D} ( {T}_{fbh} - {T}_{eibh} ) + {T}_{fbh} {ϕ}_{D} ]\end{matrix}}{{A}_{D} {T}_{fbh}} \qquad ( 1.43 )$$

Eqs. 1.38 and 1.39 are used to convert the profile from the dimensionless domain to the real domain by knowing the fixed fluid temperature at the bottom hole of the well, T_{fbh}, and the depth of the well, L.

It should be noted that certain assumptions have been made during the mathematical modeling described above. The assumptions for each zone are as follows:

Producing Zone (node 1-2):

In production, temperature at the perforations (T_{eibh}) is the same as the temperature of the earth calculated from the geothermal gradient.
Conduction heat transfer is neglected.
Work done by the fluid against the viscous force is neglected.
Steady State Problem (No energy accumulation in the system).
Change in P.E. is neglected.
Incompressible fluid and neglect the area change between the two nodes, so change in K.E. is neglected.
   In Front of the Producing Zone (node 2-2′)
Steady state (No mass or energy accumulation).
Neglect change in P.E. and K.E.
No loss or gain of heat during mixing (adiabatic mixing).
Fluid is incompressible or compressibility is very small.
Work done by the fluid against the viscous force is neglected.
Mixing takes place at constant pressure.
The mixture heat capacity is constant.
   Nonproducing Zone (node 4-3)
Work done by the fluid against the viscous forces is neglected.
Thermal conductivity is constant.
Heat conducted from the producing zone is neglected.
   Well Path (node 2′-5)
Steady state problem (No energy, mass, and momentum accumulation in the system).
Work done by the fluid against the viscous forces is neglected.
Constant heat flux from the tubing to the casing and from the casing to the surroundings at each control volume.
Thermal resistance of pipe and steel is neglected compared to that of the fluid in the tubing/casing annulus.
Incompressible fluid and no area change, so change in K.E. is neglected.

The temperature forward modeling derived above also can be applied to multi-layer or multi-zone wells for both single and multi-phase liquid production. As illustrated in the example of FIG. 8, well 24 is a single-phase, multi-layer production well having nonproducing zones 86, 88 and producing zones 90, 92. The completion 22 extends downwardly into wellbore 26 through a pair of packers 46. This schematic representation also illustrates a thermal nodal analysis used to develop a mathematical temperature model by determining the temperature at each of a plurality of nodes, labeled 1, 2, 2′, 3, 4, 5, 5′, 6, 7, 8, and 9.

The difference between the single layer and the two layer production is in the nodal analysis between nodes 5-5′, nodes 8-7, and nodes 5′-9, as well as a minor change between nodes 2′-5. The main differences between the single layer and the two layer production will be mentioned for each of these nodes.

Node 2′-5

The ordinary differential equation given across these nodes for single layer production, Eq. 1.42, is the same as that used for the two layer production. However, the boundary condition that will be used is more general such as: T_{fD}(z_{D}=z_{dbh})=T_{fdbh} This general boundary condition enables handling of the two or multi-layer production cases as the temperature at node 5′ should be corrected due to the mixing between the two streams and also due to the change of the rate from q₁ to q₁+q₂. In this case, the well is treated as having different sections, each having the same equation but different boundary condition depending upon the temperature of the previous section.
The solution of Eq. 1.42 using the above general boundary condition has been performed using Mathematical software, and the solution is as follows:

$${T}_{fD} = \frac{1}{{A}_{D} {T}_{fbh}} \cdot [ {ⅇ}^{- {A}_{D} {z}_{dbh}} \cdot ( \begin{matrix}{ⅇ}^{{A}_{D} {z}_{dbh}} \cdot ( \begin{matrix}{A}_{D} {T}_{eibh} - \\ {G}_{T} Sin θ ( {A}_{D} {z}_{D} L + L ) - \\ {T}_{fbh} {ϕ}_{D}\end{matrix} ) + \\ {ⅇ}^{{A}_{D} {z}_{D}} \cdot ( \begin{matrix}- {A}_{D} {T}_{eibh} + {A}_{D} {T}_{fbh} {T}_{fdbh} + \\ {G}_{T} Sin θ ( {A}_{D} {z}_{dbh} L + L ) + {T}_{fbh} {ϕ}_{D}\end{matrix} )\end{matrix} ) ] \qquad ( 2.1 )$$

Where, T_{fdbh} is the temperature of entry and z_{dbh} is the depth measured from the bottom of the well at the entry level. Eqs. 1.38 and 1.39 are used to convert the dimensionless temperature profile obtained from Eq. 2.1 to the real domain

Node 5-5′

The modeling between node 5 and 5′ is very similar to that between node 2 and 2′ for the single layer production presented above in that both mass and energy balance are applied. Also, the assumptions used between nodes 2 and 2′ are the same as between nodes, 5 and 5′ except the last assumption where the heat capacity of the two streams are not the same and also the mixing rates are not equal. Similarly, by dividing the producing zone into equal intervals, each interval produces at an equal rate. The number of divisions depends upon the number of temperature measurements in the producing zone. By applying a macroscopic mass and energy balance due to the mixing of two streams from the upper producing zone and the total rate obtained from the lower zone, the temperature at any interval inside the producing zone can be obtained using the following derived equation:

$${T}_{f ( i )} = \frac{[ {q}_{1} + ( i - 1 ) \cdot ( \frac{{q}_{2}}{n} ) ] {C}_{p ( i )} {T}_{f ( i - 1 )} + \frac{{q}_{2}}{n} {C}_{p 2} {T}_{ei}}{( {q}_{1} + ( i - 1 ) \cdot \frac{{q}_{2}}{n} ) {C}_{p ( i )} + \frac{{q}_{2}}{n} {C}_{p 2}} \qquad ( 2.2 )$$

Where, i=1, 2, . . . , n (n is the number of divisions or the number of temperature measurements inside the upper producing zone);
T_{f(i)} is the temperature at each interval inside the producing zone; T_{f(0)} is the wellbore temperature at node 5;
Cₚ₂ is the specific heat capacity of the fluid in the upper producing zone;
q₁, q₂ is the total production from the lower zone and upper zone, respectively; and
Cₚ₍ᵢ₎ is the specific heat capacity at each interval inside the producing zone and is calculated as a rate weighting average according to the following equation:

$${C}_{p ( i )} = \frac{[ {q}_{1} + ( i - 1 ) \cdot ( \frac{{q}_{2}}{n} ) ] {C}_{p ( i - 1 )} + \frac{{q}_{2}}{n} {C}_{p 2}}{[ {q}_{1} + ( i ) \cdot \frac{{q}_{2}}{n} ]} \qquad ( 2.3 )$$

Where, i=1, 2, . . . , n and Cₚ₍₀₎=Cₚ₁ which is the specific heat capacity of the fluid produced from the lower zone, which is constant through the section between node 2′ and 5.
At node 5′,
T_{5′}=T_{f(n)} (2.4)
Also,
C_{p5′}=Cₚ₍ₙ₎ (2.5)
It should be noted that unlike Eq. 1.11, which is used to model the temperature from the lower producing interval (node 2-2′), Eqs. 2.2 and 2.3 are rate dependent. However, it should also be mentioned that as the total rate from the two producing zones are null or very close to zero, Eqs. 2.2 and 2.3 will not work, so a condition must be imposed such that at very small or zero rates from the two producing zones, the temperature is assumed equivalent to the geothermal temperature. Also, it should be noted that Tₑᵢ in Eq. 2.2 could be corrected due to the pressure drop across the perforation in a way similar to that described above by using Eqs. 1.8 and 1.9. Alternatively, the Joule-Thomson effect can be neglected and Ti will be the geothermal temperature.

Node 8-7

The equation described above for use between nodes 3 and 4 can be used between nodes 8 and 7. However, the flow rate is the total rate from the two producing zones.

Node 5′-9

Eq. 2.1 can be used to describe the temperature profile between node 5′ and 9 by using the total rate (q₁+q₂) instead of q₁. Also, Cₚ between node 5′ and 9 is equal to C_{p5′} as calculated from Eq. 2.5.

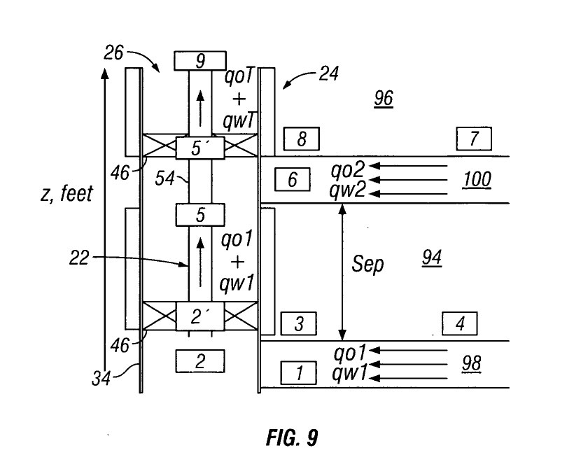

The temperature forward modeling derived above also can be applied to multi-layer, multi-zone wells, such as a two-phase (oil-water) liquid, two-layer production well. As illustrated in the example of FIG. 9, well 24 is a multi-phase liquid, multi-layer production well having nonproducing zones 94, 96 and producing zones 98, 100. The completion 22 extends downwardly into wellbore 26 through a pair of packers 46. The schematic representation further illustrates a thermal nodal analysis used to develop a mathematical temperature model by determining the temperature at each of a plurality of nodes, labeled 1, 2, 2′, 3, 4, 5, 5′, 6, 7, 8 and 9.

The extension of the modeling to two-phase liquid flow depends upon recalculating the parameters of the modeling for the two-phase flow. The equation for each parameter will differ depending upon the nodal location, thus, the equation for each parameter will be given between each node with a special reference to the equation used in the temperature modeling. It should be noted that in the nonproducing zone as there is no fluid flow, only heat energy flow, the change from single-phase to two-phase liquid flow will not affect the temperature modeling between nodes 3 and 4 and-nodes 8 and 7. Also, it should be mentioned that the correction of the temperature due to the pressure drop in front of the producing interval is neglected.

Node 2-2′

As seen from Eq. 1.11, the temperature modeling between nodes 2 and 2′ depends only on the geothermal temperature, which does not depend upon the production phase. Therefore, the temperature modeling between nodes 2 and 2′ is the same as for single-phase flow.

Node 2′-5

Eq. 2.1 is used to get the temperature distribution between nodes 2′ and 5. The parameters that are obtained due to the two-phase liquid flow are as follows:
First, for A_{D} calculation the parameters are: wₜ and Cₚ. wₜ is calculated using Eq. 1.22a where q_{w1} is substituted for q_{w} and qₒ₁ is substituted for qₒ, while Cₚ between nodes 2′ and 5 is calculated according to the following equation:

$${C}_{p 1} = \frac{{C}_{po} \cdot {q}_{o 1} + {C}_{pw} \cdot {q}_{w 1}}{{q}_{o 1} + {q}_{w 1}} \qquad ( 2.6 )$$
Second, with respect to the φ_{D} parameters, those parameters obtained for the two-phase flow are: q, Cₚ, μ, ρ. The parameters are obtained as follows:
q=q₁=qₒ₁+q_{w1} (2.7)
Cₚ is calculated as given by Eq. 2.6

$$\begin{matrix}μ = {μ}_{1} = \frac{{μ}_{o} \cdot {q}_{o 1} + {μ}_{w} \cdot {q}_{w 1}}{{q}_{o 1} + {q}_{w 1}} & ( 2.8 ) \\ ρ = {ρ}_{1} = \frac{{ρ}_{o} \cdot {q}_{o 1} + {ρ}_{w} \cdot {q}_{w 1}}{{q}_{o 1} + {q}_{w 1}} & ( 2.9 )\end{matrix}$$

Node 5-5′

Eqs. 2.2 and 2.3 are used to calculate the temperature between these nodes by substituting (qₒ₁+q_{w1}) for q₁ and (qₒ₂+q_{w2}) for q₂. Cₚ₂ is calculated from the following equation:

$${C}_{p 2} = \frac{{C}_{po} \cdot {q}_{o 2} + {C}_{pw} \cdot {q}_{w 2}}{{q}_{o 2} + {q}_{w 2}} \qquad ( 2.10 )$$

Node 5′-9

The temperature distribution between nodes 5′ and 9 is similar to that between nodes 2′-5 but with the following differences:
For wₜ, it is calculated using Eq. 1.22a, where q_{w}=q_{wT}=q_{w1}+q_{w2} and qₒ=q_{oT}=qₒ₁+qₒ₂
For Cₚ, it is calculated using the following equation:

$${C}_{pM} = \frac{{C}_{po} \cdot ( {q}_{o 1} + {q}_{o 2} ) + {C}_{pw} \cdot ( {q}_{w 1} + {q}_{w 2} )}{{q}_{o 1} + {q}_{o 2} + {{q}_{w}}_{1} + {{q}_{w}}_{2}} = {C}_{p {5}^{′}} \qquad ( 2.11 )$$

For the φ_{D} calculation the parameters calculated are:

$$\begin{matrix}q = {q}_{o 1} + {q}_{w 1} + {q}_{o 2} + {q}_{w 2} & ( 2.12 ) \\ μ = \frac{{μ}_{o} \cdot ( {q}_{o 1} + {q}_{o 2} ) + {μ}_{w} \cdot ( {q}_{w 1} + {q}_{w 2} )}{{q}_{o 1} + {q}_{w 1} + {q}_{o 2} + {q}_{w 2}} & ( 2.13 ) \\ ρ = \frac{{ρ}_{o} \cdot ( {q}_{o 1} + {q}_{o 2} ) + {ρ}_{w} \cdot ( {q}_{w 1} + {q}_{w 2} )}{{q}_{o 1} + {q}_{w 1} + {q}_{o 2} + {q}_{w 2}} & ( 2.14 )\end{matrix}$$

The extension of the temperature modeling to multi-layer, two-phase liquid flow is trivial as it is only an extension of the equations discussed above following the same steps as in the extension from single layer to two layers.

An appropriate temperature forwarding model, as discussed above, is used as the forward tool in inverting the temperature measurements inside an operating well. The operating well may be, for example, a producing well or a well under treatment. Inverting the temperature measurements enables allocation of fluid flow rates from producing layers.

In a broad sense, inversion is finding the independent parameters in the forward model that minimize the error between the measured dependent parameter and the calculated dependent parameter from the forward model. Accordingly, it becomes an optimization problem in which it is desirable to minimize a certain objective function, which is the error between the measured and the calculated dependent parameters, by changing the independent parameters in a certain domain. In other words, the independent parameters can be changed according to specified constraints.

As discussed above, with respect to the subject well applications, the dependent parameter is temperature and the independent parameters are mainly the zonal rates, although there could be other input parameters of the forward modeling. Accordingly, the mathematical description of the optimization problem is as follows:

$$Min O ( m ) = Min [ {\sum }_{i = 1}^{{n}_{d}} {( {T}_{i}^{cal} ( m ) - {T}_{i}^{obs} )}^{2} ]$$

subject to {any constaints on m}
Where, m: is a vector of the independent parameters, mainly the zonal rates and/or other input parameters.

The inversion process can be used to minimize, e.g. compensate for, various errors as discussed above. Several optimization algorithms may be used to determine the zonal rate or rates by minimizing the error between the temperature measured from, for example, distributed temperature sensor 40 and the calculated temperature from the forward modeling, such as the forward models discussed previously. However, one optimization algorithm that works well and is relatively straightforward is the “Generalized Reduced Gradient” algorithm that is coded in Excel® software available from Microsoft Corporation. The Excel® software can be, for example, loaded onto control 42 and utilized by an operator in determining fluid flow rates from well zones based on the temperature input data obtained from the well via distributed temperature sensor 40 and control 42. An inverse modeling with the Generalized Reduced Gradient optimization algorithm can thus be used to invert for the zonal rate allocation by minimizing the difference between the measured temperature from the distributed temperature sensor 40 and the calculated temperature from the forward model.

Testing has shown a high level of accuracy in the zonal rate allocation based on distributed temperature sensor measurements in a variety of applications and under varying conditions. For example, in single-phase liquid production in an environment with high temperature contrast between producing zones, the zonal rates can be allocated with high accuracy, even without imposing the total rate as a constraint in the optimization. In a single-phase liquid production with low temperature contrast between producing zones, the zonal rates can be allocated with high accuracy, particularly if the total rate is added as a constraint in the optimization. Another example is two-phase liquid production in which oil and water are produced with high temperature contrast between producing zones. In this application the zonal rates were allocated with high accuracy when using the total rate for each production phase as a constraint in the optimization. If more than two zones are inverted, accuracy can sometimes be improved by determining the total phase rate above each two producing zones. However, this does not mean the inversion is not useful if only one total rate is imposed for each phase above more than two producing intervals.

Although, only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A method of determining production rates in a well, comprising:
determining a model of temperature as a function of zonal flow rates in the well;
measuring temperatures at a plurality of locations in the well; and
inverting the measured temperatures by applying the model to determine an allocation of production rates from different producing zones in the well.

2. The method as recited in claim 1, wherein determining comprises determining the model for a single-phase liquid producing well.

3. The method as recited in claim 1, wherein determining comprises determining the model for a multi-layer producing well.

4. The method recited in claim 1, wherein determining comprises determining the model for a multi-layer, single-phase liquid producing well.

5. The method as recited in claim 1, wherein determining comprises determining the model for a multi-layer, multi-phase liquid producing well.

6. The method as recited in claim 1, wherein measuring comprises measuring temperature with a distributed temperature sensor.

7. The method as recited in claim 1, wherein inverting comprises determining a degree of certainty in the production rates allocated.

8. The method as recited in claim 7, wherein determining the degree of certainty comprises determining a degree of error in the model.

9. The method as recited in claim 7, wherein determining the degree of certainty comprises determining a degree of error in the measured temperatures.

10. The method as recited in claim 7, wherein determining the degree of certainty comprises determining a degree of error in well parameter values.

11. The method as recited in claim 1, wherein inverting comprises utilizing a generalized reduced gradient optimization algorithm.

12. A method of determining flow rates in a well, comprising:
measuring temperature at a plurality of points along the well having a plurality of well zones and a plurality of liquid phases; and
determining flow rates of the plurality of liquid phases through each of the plurality of well zones via the measured temperatures.

13. The method as recited in claim 12, wherein measuring comprises utilizing a distributed temperature sensor.

14. The method as recited in claim 12, wherein determining comprises constructing a model of temperature as a function of zonal flow rates in the well, and using the model to invert the measured temperatures in allocating flow rates from the plurality of well zones.

15. The method as recited in claim 12, wherein determining comprises determining flow rates of oil and water phases during production.

16. The method as recited in claim 12, wherein determining comprises determining flow rates of fluid injected into each of the plurality of well zones.

17. The method as recited in claim 14, wherein inverting the temperatures comprises utilizing an optimization algorithm.

18. The method as recited in claim 12, wherein determining comprises measuring a total flow rate at a wellhead.

19. A system, comprising:
a temperature sensor deployable with a production completion along a wellbore to sense temperature data at a plurality of wellbore locations during production; and
a processor system able to receive the temperature data and allocate a flow rate from a plurality of wellbore zones based on the temperature data.

20. The system as recited in claim 19, wherein the processor system uses a temperature forward model, in which temperature is a function of zonal flow rates, to invert the temperature data and allocate flow rates from producing layers of a formation.

21. The system as recited in claim 19, wherein the temperature sensor comprises a distributed temperature sensor.

22. The system as recited in claim 19, wherein the processor system is able to allocate flow rates in a multi-layer, multi-phase liquid producing well.

23. The system as recited in claim 19, wherein the production completion comprises an electric submersible pumping system.

24. The system as recited in claim 19, wherein the production completion comprises a gas lift system.

25. The system as recited in claim 19, wherein the wellbore is oriented generally vertically.

26. A method, comprising:
deploying a distributed temperature sensor along a wellbore;
utilizing a model of temperature as a function of fluid flow rates into the wellbore;
obtaining temperature data from the distributed temperature system;
allocating a fluid flow rate in at least one wellbore zone using the temperature data in conjunction with the model; and
determining error in the fluid flow rate.

27. The method as recited in claim 26, wherein allocating comprises inverting the temperature data to obtain the fluid flow rate.

28. The method as recited in claim 26, wherein deploying comprises deploying the distributed temperature system in a generally vertical wellbore.

29. The method as recited in claim 26, wherein deploying comprises deploying the distributed temperature system in a deviated wellbore.

30. The method as recited in claim 26, wherein allocating comprises determining fluid flow rates across a plurality of wellbore zones.

31. The method as recited in claim 26, wherein allocating comprises determining flow rates for a single-phase liquid producing well.

32. The method as recited in claim 26, wherein allocating comprises determining flow rates for a multi-phase liquid producing well.

33. The method as recited in claim 26, wherein determining comprises compensating for model error, measurement error, and well parameter error.

34. A system, comprising:
means for measuring temperature at a plurality of points along a well having a plurality of well zones and a plurality of liquid phases; and
means for determining flow rates of the plurality of liquid phases through each of the plurality of well zones via the measured temperatures.

35. The system as recited in claim 34, wherein the means for measuring comprises a distributed temperature sensor.

36. The system as recited in claim 34, wherein the means for determining comprises a processor system able to receive the temperature data and allocate a flow rate from a plurality of wellbore zones based on the temperature data.
